(19) United States
(12) Patent Application Publication
(10) Pub. No.: US 2006/0127002 A1
(43) Pub. Date: Jun. 15, 2006

(54) Light transfer component

(76) Inventors: James Bruce Franklin, Camperdown (AU); Geoffrey Burton Smith, Epping (AU)

Correspondence Address: LADAS & PARRY LLP, 224 SOUTH MICHIGAN AVENUE, SUITE 1600, CHICAGO, IL, 60604, US

(21) Appl. No.: 10/531,759

(22) PCT Filed: Oct. 24, 2003
(86) PCT No.: PCT/AU03/01415

§ 371 Date: Sep. 7, 2005

(30) Foreign Application Priority Data
Oct. 24, 2002 (AU) 2002952276

(51) Int. Cl. G02B 6/42

(52) U.S. Cl. 385/31

(57) ABSTRACT

The present invention provides a light transfer component formed from a material that is transparent for light of a predetermined range of wavelengths. The light transfer component comprises a first substantially flat portion, a second rounded portion, and an intermediate portion disposed between the first and the second portion. The light transfer component is arranged for guiding light from the first portion through the intermediate portion to the second portion in a manner such that the light will not experience a reduction in cross-sectional area of more than 20% of the material through which it is guided.

### FIELD OF THE INVENTION

The present invention broadly relates to a light transfer component for use in a daylight collection and transfer system.

### BACKGROUND OF THE INVENTION

Electrical lighting systems are often very inefficient; usually more than 90% of the electrical energy is not converted into useful light. Sunlight, however, is freely available and attempts have been made to collect sunlight for illumination purposes.

U.S. Pat. No. 6,059,438 discloses a sunlight collecting and transmitting system. The disclosed system comprises three flat collector sheets. The three sheets are stacked on top of each other and are composed of a polymeric material that is doped with fluorescent dye molecules. The dye molecules absorb sunlight of a particular wavelength and subsequently emit fluorescent light having a slightly longer wavelength. A first sheet is doped with blue dye molecules, a second sheet is doped with green dye molecules and a third sheet is doped with red dye molecules. The generated fluorescent light is guided by total internal reflection within the collector sheets and white light can be generated by combining the blue, green and red fluorescent light. One of the advantages of this sunlight collecting and transmitting system is that both the absorption of the incoming light and the emission of the fluorescent light do not occur in any preferred directions. The efficiency of such a system therefore is largely independent of the direction of the incoming sunlight.

The generated light needs to be guided from the collector sheets into buildings to illuminate the interior of the buildings. However, as the light is guided by total internal reflection, light transference losses occur if geometrical constraints are not satisfied which is a problem for the transfer of sunlight in a convenient and efficient manner. For example, it would be useful to transfer light by cable-like conductors.

### SUMMARY OF THE INVENTION

The present invention provides in a first aspect a light transfer component formed from a material that is transparent for light of a predetermined range of wavelengths, the light transfer component comprising:

a first portion being substantially flat,

a second solid rounded portion, and

an intermediate portion disposed between the first and the second portion, the intermediate portion being at least in part hollow and rounded,

wherein the light transfer component is arranged for guiding light from the first portion through the intermediate portion to the second portion.

The present invention provides in a second aspect a light transfer component formed from a material that is transparent for light of a predetermined range of wavelengths, the light transfer component comprising:

a first portion being substantially flat,

a second solid rounded portion, and

an intermediate portion disposed between the first and the second portion, the intermediate portion being at least in part hollow and rounded,

wherein the light transfer component is arranged for guiding light from the first portion through the intermediate portion to the second portion and

wherein the light transfer component is arranged so that light guided from the first portion to the second portion will not experience a reduction in cross-sectional area of more than 20% of the material through which the light is guided.

The following description relates to the light transfer component according to the first and according to the second aspect of the present invention.

Throughout this specification the term “rounded” is used for any shape that is non-angular. For example, this may include oval shapes or generally curved shapes. Also, the term “cross-sectional area” is used for a cross-sectional area measured transversely to the mean direction of light propagation.

The light transfer component typically is arranged for guiding light from the first portion through the intermediate portion to the second portion in a manner such that the light will not experience a reduction in cross-sectional area of the material through which it is guided.

It will be appreciated that the term “will not experience a reduction in cross-sectional area” is to be understood as having a broad meaning allowing the reduction of the cross-sectional area by a few percent.

The inventors have determined that collectors for sunlight preferably should be of a form that is substantially flat. However, the light is most conveniently guided in an optical cable having a generally cylindrical form such as a flexible, solid and round polymeric cable which, for example, may have a diameter of 25 mm or less. The optical cable may have a single core or may comprise a bundle of optical fibres. In one embodiment, the above-defined light transfer component provides a link between such a light collector sheet (or a stack of such sheets) and the optical cable and enables the efficient transfer of light through the link. The light transfer component may also include at least one light collector sheet and the optical cable. In this case, the light collector component may include a stack of light collector sheets.

In one specific embodiment the cross-sectional area is substantially constant throughout the light transfer component and in use the average solid angle of the propagating light may also be substantially constant throughout the light transfer component. Further, the refractive index may be constant throughout the light transfer component.

Alternatively, the light transfer component may be arranged such that light directed from the first portion to the second portion will experience an increase in cross-sectional area of the material through which, in use, light is guided. For example, this may be the case if the second portion is coupled to, or comprises, a light guide that has a cladded core region and the cladding has a refractive index greater than air. The light transfer component may be arranged so that in use the product of cross-sectional area and average solid angle changes by less than 20% for light directed from the first component to the second component and in a specific embodiment is substantially constant.

The second rounded portion of the light transfer component may be cladded with a material of low refractive index. Further, the intermediate portion may be cladded with the material of low refractive index. The material of low refractive index may be a polymeric material.

The first portion may be bent or profiled in any way and may be corrugated. The first portion may have two substantially parallel surfaces and in a specific embodiment is of a substantially rectangular cross-sectional shape. In a specific embodiment the first portion is arranged for connection with a light collector sheet and has a cross-sectional profile that matches that of the light collector sheet. For example, the first portion may comprise a rectangular sheet, the substantially parallel surfaces being the top and the bottom of the sheet.

The transfer component may be arranged such that, in use, light guided from the first portion to the second portion will experience a gradual transition in the cross-sectional and longitudinal profiles of the light transfer component. In a particular embodiment the changes in the profile are sufficiently gradual such that there are negligible bending losses of the light when the light is guided in the component.

The light transfer component may be arranged for connection to an optical light guiding device such as an optical cable or to a light converting device such as a device that converts light into electrical energy. The light transfer component may be arranged for face-to-face connection with the optical cable.

The first portion may be arranged for direct connection to at least one light collector sheet and may be arranged for face-to-face connection with the or each light collector sheet. In this case the light collector sheet and the light transfer component may include elements that assist their assembly into an integrated optical system. For example, the light collector sheet and the light transfer component may be arranged for male-to-female connection and may comprise features that allow a tongue-and-groove-type connection. The first portion may also comprise at least one light collector sheet doped with dye molecules and arranged for absorption of sunlight and emission of fluorescent radiation. The or each light collector sheet and the light transfer component may be integrally formed.

The light transfer component preferably may be formed from a transparent material with a refractive index that approximates that of the or each light collector sheet. In a specific embodiment the material is a polymeric material such as poly methyl methacrylate (PMMA).

The present invention also provides in a third aspect a light transfer component formed from a material that is transparent for light of a predetermined range of wavelengths, the light transfer component comprising:

a first substantially flat portion,

a second solid rounded portion, and

an intermediate portion disposed between the first and the second portion,

the light transfer component being arranged for guiding light from the first portion through the intermediate portion to the second portion in a manner such that the light will not experience a reduction in cross-sectional area of more than 20% of the material through which it is guided.

The present invention provides in a fourth aspect a light transfer component formed from a material that is transparent for light of a predetermined range of wavelengths, the light transfer component comprising:

a first substantially flat portion,

a second solid rounded portion, and

an intermediate portion disposed between the first and the second portion,

the light transfer component being arranged for guiding light from the first portion through the intermediate portion to the second portion in a manner such that the light will not experience a reduction in cross-sectional area of the material through which it is guided.

The present invention provides in a fifth aspect a light transfer component comprising

spaced apart first and second portions, the first portion being flat so as to present a cross-sectional surface that is suitable to receive light from a light collector sheet, the second portion being rounded and solid in cross-section, and

an intermediate portion disposed between the first and the second portion and arranged to transfer light from the first portion to the second portion, the intermediate portion having a cross-sectional shape that varies along its length from the flat portion to the rounded portion and through a portion that incorporates a hollow core.

Specific embodiments will now be described, by way of example only, with reference to the accompanying drawings.

### BRIEF DESCRIPTION OF THE DRAWINGS

FIG. 1 shows a perspective representation of a light transfer component according to an embodiment,

FIG. 2 shows a perspective exploded view of a light collector component according to another embodiment and

FIG. 3 shows a ray-tracing diagram of the light transfer component.

### DETAILED DESCRIPTION OF SPECIFIC EMBODIMENTS

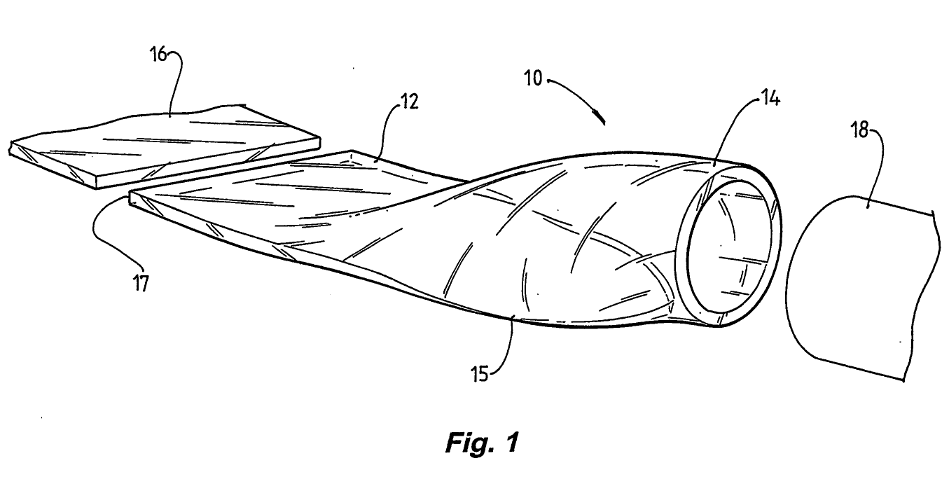

Referring to FIG. 1, a light transfer component is now described. In this embodiment the light transfer component 10 has a rectangular portion 12 and a hollow, ring-like portion 14 between and an intermediate portion 15 is disposed between portion 12 and portion 14. The rectangular portion 12 is shaped such that it may be joined face-to-face with a light collector sheet 16. The surfaces of all components are optically smooth; that is they have a roughness smaller than the wavelength of the light guided in them.

In this embodiment the rectangular portion 12 has an end-face 17 that has the same cross-sectional shape as light collector sheet 16. In use, the end-face 17 is joined with the light collector sheet 16 using a suitable optical joint. This may be achieved by optically transmissive adhesive, optical welding, refractive index matching gel or other suitable means. In a variation of this embodiment, the light collector sheet 16 is replaced by a stack of light collector sheets which are, in use, joined with end face 17.

The hollow, ring-like portion 14 is arranged to be connected to a further light transfer component such as a hollow-to-solid coupler 18 which is connected to an optical cable (not shown).

In an alternative embodiment the rectangular portion 12 is a part of the light collector sheet 16 and may be integrally formed with the light collector sheet 16. In a variation of this embodiment the light collector sheet 16 may be replaced by a stack of light collector sheets.

U.S. Pat. No. 6,272,265 discloses ways in which the output of a fluorescent sunlight collector and transmission system can be substantially increased provided that the system is constructed so that it is optically continuous i.e. without air gaps along the optical path.

Fluorescent light that is generated in the light collector sheet 16 is guided into the light transfer component 10. The light transfer component 10 is shaped such that light guided by total internal reflection from the substantially rectangular portion 12 through the intermediate portion 15 to the ring-like portion 14 will experience a gradual transition and will not experience a reduction in the cross-sectional area. The transition occurs over a distance corresponding to several times the width of the sheet from which the light transfer component is formed. The light transfer component 10 is shaped such that minimal bending loses occur when light is guided through the light transfer component 10.

In this embodiment the light transfer component 10 is formed from PMMA. The light transfer component 10 may be prepared by injection moulding or by casting. All surfaces are optically smooth to reduce optical scattering losses. If required, surface roughness may be reduced by applying a solution of dimethyl methacrylate to the surface of the light transfer component 10. The edges are arranged that right angles are formed whereby loss of light transported by total internal reflection is reduced.

In a variation of this embodiment the end-face of the ring-like portion 14 is joined directly with an end-face of an optical cable without a hollow-to-solid coupler. In this case part 18 in FIG. 1 represents an optical cable. In this embodiment the optical cable has a single core. However, it will be appreciated that in an alternative embodiment the optical cable may comprise a bundle of optical fibres. The ring-like portion 14 has an outer diameter that matches the outer diameter of the light guiding portion of the optical cable.

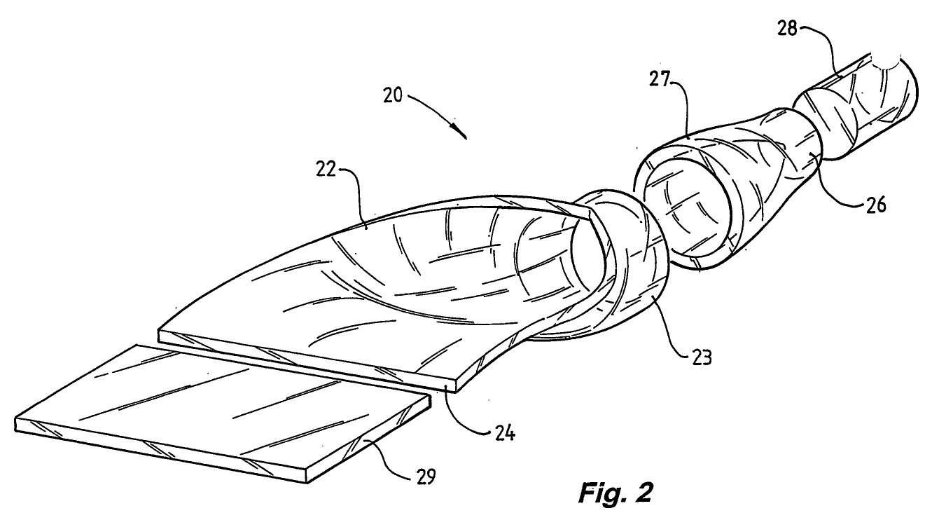

FIG. 2 shows and exploded perspective view of another embodiment. In this embodiment the light transfer component 20 comprises portion 22 which has a hollow and ring-like end-face 23 and an opposing rectangular end-face 24. The ring-like end-face 23 is joined to a hollow-to-solid coupler 27 such that the light transfer component comprises a further intermediate portion that is hollow. It will be appreciated that in a variation of this embodiment the portion 22 and the hollow-to-solid coupler 27 may also be formed as one integral part. The hollow-to-solid coupler has a round end-face 26 that is solid and is arranged for coupling to a polymeric optical cable 28. The rectangular end-face of portion 24 of the portion 22 is arranged to be joined to a light collector sheet 29 (again, the light collector sheet 29 may be a stack of light collector sheets).

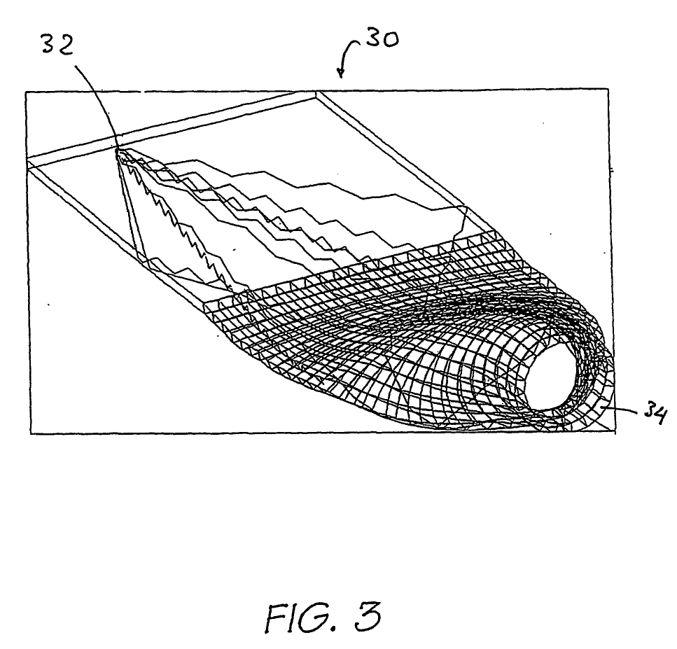

FIG. 3 shows a ray-tracing diagram for the light transfer component 10 shown in FIG. 1. The light transfer component 30 comprises dye molecules 32 that may emit fluorescence radiation in a variety of directions and the radiation is guided by total internal reflection towards the ring-like portion 34. The Figure shows an arbitrary selection of possible ray traces.

Even though this invention has been described in the context of a light collection and transfer system that absorbs sunlight and generates fluorescence radiation, it will be appreciated that the invention has broader applications. The light transfer component may be used for transfer of light originating from any source. Further, it will be appreciated that the light transfer component may be arranged for transfer of light to any type of light guiding or light converting device either directly or via a coupler.

It is to be understood that the references that are made to U.S. Pat. Nos. 6,059,438 and 6,272,265 do not constitute admissions that these documents form part of the common general knowledge in the art, in Australia or any other country.

1-33. (canceled)

34. A light transfer component formed from a material that is transparent for light of a predetermined range of wavelengths, the light transfer component comprising:
a first portion being substantially flat,
a second solid rounded portion, and
an intermediate portion disposed between the first and the second portion, the intermediate portion being at least in part hollow and rounded,
wherein the light transfer component is arranged for guiding light from the first portion through the intermediate portion to the second portion.

35. The light transfer component as claimed in claim 34 being arranged so that light guided from the first portion to the second portion will not experience a reduction in cross-sectional area of the material through which the light is guided.

36. The light transfer component as claimed in claim 34 wherein the cross-sectional area is substantially constant throughout the light transfer component.

37. The light transfer component as claimed in claim 34 wherein in use the average solid angle of the propagating light is substantially constant throughout the light transfer component.

38. The light transfer component as claimed in claim 34 being arranged so light guided from the first portion to the second portion will experience light guiding condition in which in use the product of cross-sectional area and the average solid angle is substantially constant.

39. The light transfer component as claimed in claim 34 wherein refractive index is constant throughout the light transfer component.

40. The light transfer component as claimed in claim 34 having two substantially parallel surfaces.

41. The light transfer component as claimed in claim 34 wherein the first portion comprises a rectangular sheet.

42. The light transfer component as claimed in claim 34 being arranged such that light directed from the first portion to the second portion will experience an increase in cross-sectional area of the material through which the light is guided.

43. The light transfer component as claimed in claim 34 being arranged so that in use light guided from the first portion to the second portion will experience light guiding condition in which the product of cross-sectional area and average solid angle will not change by more than 20%.

44. The light transfer component as claimed in claim 34 being arranged such that, in use, light guided from the first portion to the second portion will experience a gradual transition in the cross-sectional and longitudinal profiles of the light transfer component.

45. The light transfer component as claimed in claim 44 wherein the changes in profile are sufficiently gradual such that there are negligible bending losses of the light when the light is guided through the transfer component.

46. The light transfer component as claimed in claim 34 being arranged for connection to an optical cable.

47. The light transfer component as claimed in claim 46 being arranged for face-to-face connection to the optical cable.

48. The light transfer component as claimed in claim 34 being arranged for face-to-face connection to a light converting device.

49. The light transfer component as claimed in claim 34 being arranged for direct connection to at least one light collector sheet.

50. The light transfer component as claimed in claim 49 wherein the first portion is arranged for face-to-face connection with the or each light collector sheet.

51. The light transfer component as claimed in claim 34 wherein the first portion comprises at least one light collector sheet doped with dye molecules and arranged for absorption of sunlight and emission of fluorescent radiation.

52. The light transfer component as claimed in claim 51 wherein the or each light collector sheet and the light transfer component are integrally formed.

53. The light transfer component as claimed in claim 49 being formed from a transparent material with a refractive index that approximates that of the or each collector sheet.

54. The light transfer component as claimed in claim 53 wherein the material is poly methyl methacrylate (PMMA).

55. The light transfer component as claimed in claims 46 wherein the optical cable has a single core.

56. The light transfer component as claimed in claims 46 wherein the optical cable comprises a bundle of optical fibres.

57. The light transfer component as claimed in claim 34 wherein the second rounded portion of the light transfer component is clad with a material of low refractive index.

58. The light transfer component as claimed in claim 34 wherein the intermediate portion of the light transfer component is clad with the material of low refractive index.

59. A light transfer component comprising
spaced apart first and second portions, the first portion being flat so as to present a cross-sectional surface that is suitable to receive light from a light collector sheet, the second portion being rounded and solid in cross-section, and
an intermediate portion disposed between the first and the second portion and arranged to transfer light from the first portion to the second portion, the intermediate portion having a cross-sectional shape that varies along its length from the flat portion to the rounded portion and through a portion that incorporates a hollow core.

60. A light transfer component formed from a material that is transparent for light of a predetermined range of wavelengths, the light transfer component comprising:
a first portion being substantially flat,
a second solid rounded portion, and
an intermediate portion disposed between the first and the second portion, the intermediate portion being at least in part hollow and rounded,
wherein the light transfer component is arranged for guiding light from the first portion through the intermediate portion to the second portion and
wherein the light transfer component is arranged so that light guided from the first portion to the second portion will not experience a reduction in cross-sectional area of more than 20% of the material through which the light is guided.

61. The light transfer component as claimed in claim 60 being arranged so that light guided from the first portion to the second portion will not experience a reduction in cross-sectional area of the material through which the light is guided.

62. The light transfer component as claimed in claim 60 wherein the cross-sectional area is substantially constant throughout the light transfer component.

63. The light transfer component as claimed in claim 60 wherein in use the average solid angle of the propagating light is substantially constant throughout the light transfer component.

64. The light transfer component as claimed in claim 60 being arranged so light guided from the first portion to the second portion will experience light guiding condition in which in use the product of cross-sectional area and the average solid angle is substantially constant.

65. The light transfer component as claimed in claim 60 wherein refractive index is constant throughout the light transfer component.

66. The light transfer component as claimed in claim 60 having two substantially parallel surfaces.

67. The light transfer component as claimed in claim 60 wherein the first portion comprises a rectangular sheet.

68. The light transfer component as claimed in claim 60 being arranged such that light directed from the first portion to the second portion will experience an increase in cross-sectional area of the material through which the light is guided.

69. The light transfer component as claimed in claim 60 being arranged so that in use light guided from the first portion to the second portion will experience light guiding condition in which the product of cross-sectional area and average solid angle will not change by more than 20%.

70. The light transfer component as claimed in claim 60 being arranged such that, in use, light guided from the first portion to the second portion will experience a gradual transition in the cross-sectional and longitudinal profiles of the light transfer component.

71. The light transfer component as claimed in claim 70 wherein the changes in profile are sufficiently gradual such that there are negligible bending losses of the light when the light is guided through the transfer component.

72. The light transfer component as claimed in claim 60 being arranged for connection to an optical cable.

73. The light transfer component as claimed in claim 72 being arranged for face-to-face connection to the optical cable.

74. The light transfer component as claimed in claims 60 being arranged for face-to-face connection to a light converting device.

75. The light transfer component as claimed in claim 60 being arranged for direct connection to at least one light collector sheet.

76. The light transfer component as claimed in claim 75 wherein the first portion is arranged for face-to-face connection with the or each light collector sheet.

77. The light transfer component as claimed in claim 60 wherein the first portion comprises at least one light collector sheet doped with dye molecules and arranged for absorption of sunlight and emission of fluorescent radiation.

78. The light transfer component as claimed in claim 77 wherein the or each light collector sheet and the light transfer component are integrally formed.

79. The light transfer component as claimed in claim 77 being formed from a transparent material with a refractive index that approximates that of the or each collector sheet.

80. The light transfer component as claimed in claim 79 wherein the material is poly methyl methacrylate (PMMA).

81. The light transfer component as claimed in claims 72 wherein the optical cable has a single core.

82. The light transfer component as claimed in claims 72 wherein the optical cable comprises a bundle of optical fibres.

83. The light transfer component as claimed in claim 60 wherein the second rounded portion of the light transfer component is clad with a material of low refractive index.

84. The light transfer component as claimed in claim 60 wherein the intermediate portion of the light transfer component is clad with the material of low refractive index.
